(19) United States
(12) Patent Application Publication
(10) Pub. No.: US 2011/0215599 A1
(43) Pub. Date: Sep. 8, 2011

(54) MODULAR EVOLUTIVE SYSTEMS FOR USE IN PANIC BARS AND SIMILAR LOCKS

(76) Inventor: José Ramón Baragaño Gonzalez, Gijon (Asturias) (ES)

(21) Appl. No.: 13/022,805

(22) Filed: Feb. 8, 2011

Related U.S. Application Data
(63) Continuation of application No. PCT/ES2009/070336, filed on Aug. 7, 2009.

(30) Foreign Application Priority Data
Aug. 8, 2008 (ES) P200802398

(51) Int. Cl. E05C 19/00

(52) U.S. Cl. 292/259 R

(57) ABSTRACT

The invention relates to a sliding panic bar comprising a casing (3) which is designed to incorporate an electrical installation and rails for self-locking latch bodies (6, 7, 8) which are released by the actuation of a blocking lever (12) centralising different actuation situations. The activation of the bar by pressure is carried out by means of a set of shuttles (41, 42, 43), a synchronous axis (37) and retaining springs (49). The system comprises a mechanism for adapting to the width of the door, for facilitating the use of the system by physically handicapped people, and for adapting to vertical bolt systems with the latch in a vertical or horizontal position. The locks of the system are adjustable in order to be able to absorb possible dilation.

This application is a Continuation of International application PCT/ES2009/070336, filed Aug. 7, 2009.

### OBJECT OF THE INVENTION

The present invention, as the title of this specification states, relates to some improvements to modular evolutive systems for use in panic bars and similar locks, with the purpose of using the new multi-functional operation modular evolutive concepts, which have been conceived and made for providing significant advantages with respect to currently existing devices.

It can be applied to all types of sliding panic bars (Type B) for emergency exits triggered by a horizontal bar, both mechanicals and electromechanicals, with inhibition and for physically disabled people.

Another object of the invention is to create a new profile of the stationary half-bar for new applications.

The envelope assembly is also simplified by adding a simple crimp.

Also an object of the invention is to include basic functional changes in order to optimize the latches' release.

Furthermore a new dynamic compensation synchronous shaft is provided.

To meet fire regulations, the function of remote and side hinged aperture is included.

It also envisages a new system for adapting standard bars to different door widths.

Another object of the invention consists of simplifying and idealizing spagnolette systems.

A new mechanism is also included in bars for physically disabled people.

According to the aforementioned, is the object of the present invention the improvement in the structure presented by these systems in order to meet the guideline premise of the UNE-EN 1125 standard, main purpose of which is to enable a safe and effective evacuation with the minimal effort.

As for the operating system for use in emergency exits for physically disabled people, the invention aims to achieve from that applications a operability under pressures much lower than those mentioned in the in-force regulations, and that its basic mechanical construction with few elements comes up to an unusual reliability and durability.

Also, the variety of panic bars is complemented by the inclusion of the horizontal spagnolettes.

In some cases, a rationalization simplifying and streamlining the implementation and alignment of the necessary complementary elements providing very smooth sliding, consequently improving the spirit of the UNE-EN 1125 standard is envisaged.

### BACKGROUND OF THE INVENTION

Currently there is no design concept, on the envelopes of the frames, for electrical panic bars.

As it is known, latches, rocker arms, spagnolette rods and elements for locking thereof, include torsion and traction springs in their configuration.

For the same reason, given the low requirement of paragraph (4.2.6) of the regulation in force in the construction of the conventional elements sensitive to the locking function, their manufacturing is usually made by stamping, not on the basis of more complex configurations providing solids of equal resistance.

The adaptation of standard bars to diverse door widths is another area that admits the redesign.

The spagnolette latches are antagonistic vectors added to main latch vector.

In emergency exits for the physically disabled people, is even more important, the Regulation guideline for minimizing the aperture force (3.18 of the Regulation).

In addition, currently the optimization of Environmental Regulations is not achieved.

Currently, generic bars used for emergency exits use torsion springs on the rotation shaft of the latch and sometimes for the recovery of spagnolette rods and levers, traction springs being also used for the recovery of the upper and lower mechanism of the spagnolette latches, latches of which are also assisted by torsion springs.

Obviously, traction and torsion springs are not exactly the most reliable.

In relation to the force required for the aperture (Standard 4.2.1), the conventional generic system uses two levers associated with respective torsion springs encased in the head for dragging the latch during all its emerging displacement, and sometimes the spagnolette rods, also with the respective torsion and traction springs for the recovery thereof.

As for the design of a panic device according to the Standard (in its paragraph 4.1.9), it should be such that the effective length of the bar is the closest to the width of the door that has been selected, but never less than 60% of it.

The variety of bars with the measures required by the user is expensive, generates stocking and delays. Often, manufacturers of emergency exit bars conventionally use two standards.

As for the conventional construction the self-locking latch in spagnolettes, this includes a torsion spring on the latch, other of traction for the mechanism recovery, and occasionally another of torsion for the recovery of the lock stopper. This generic dragging arrangement is repeated in the configuration of bars with two and three anchor points. These vectors (top, bottom spagnolettes and bar) result in a considerable counterforce, per se, for unlocking the door.

According to the above, a poor attachment of the transmitting rods (spagnolettes) to their supporting element, can produce a permanent lock on the emergency exit.

Also, the philosophy of applying retention release instead of the traditional system: traction dragging extends to the new horizontal spagnolette element. This mechanism integrates the existing modular elements in the main bar and in the vertical spagnolette mechanisms.

The recovery of the spagnolette shanks maintains the implementation of the compression spring, not those of torsion conventionally used.

The locks include impellers, no static envelopes. In some cases for their alignment, dispense with the usual supplements, incorporating a simple and aesthetic adjustment.

The guiding supporting element of the spagnolettes (both horizontal and vertical) adds to their design a simple accessory that greatly improves the installation for aligning thereof.

### DESCRIPTION OF THE INVENTION

In general, the improvements to modular evolutive systems for use in panic bars and similar locks, object of the present invention, are basically characterized in that regarding a configuration as the sliding panic bar, it includes a case bearing a boss, on which a sliding half-bar slides, through a guide made therein, thus eliminating other type of more complex assembly. There is a stationary half-bar that includes in its structure obtained by extrusion, a new configuration for the electrical installation electrified, including different recesses for prewiring different and other connections that have to be done. Crenellations for the correct alignment and movement of shuttles are envisaged, and having a necessary rigidity in their section when integrating the functions of inhibition, which sometimes appears in their variants.

Inside the rails existing in the structure of this case for modular attachment, it houses a first supporting elements joined together with head frames having a double circular sector for achieving the double depression of the latch on the positioning shafts thereof. This latch is characterized in that it includes an elevated self-locking member forming a compensating spring balance, being displaced from its geometric center for receiving a recuperating rod which, by means of the groove therein, moves along the positioning shaft together with its compression spring, and pivots on a shaft of a locking lever, thus replacing the classic torsion spring.

It has been envisaged that this locking lever, solid of equal resistance, performs the functions of: serving as unlocking element by actuating the follower on its external and adjacent addendum, sometimes on the application shaft during the exit of physically disabled people. This locking lever also performs the function of armor in electrical configurations, houses its return spring and ensures that in case of fire, when the fuse provided for such purpose is melted, this lever is retained by a spring maintaining the lock.

Moreover, head frames at its top are assembled with the supporting element of the coil for making up the stiffness of the head block. Another improvement of the invention is to include a skid, crimped or not, to electromagnetic armor made of different alloys (same as its core in inhibition applications), determining a solid of equal resistance, having at its top a triangular-prism configuration and in the middle maintaining the parallelism with the situation of some rods connected thereto and articulated on its shaft and on that of the latch. At its back, an open crenellation wherein a bushing for moving the synchronous shaft rigidly joined to the operating levers is housed, is formed in their lower shafts in the first operating lever and another in the second one. Thus it is independently moved, not associated with dragging the emerging element. These lower shafts or rapiers are assembled with the shutters hosted in the crenellations, which for this purpose includes the stationary half-bar.

It has also envisaged that the springs provided in the synchronous shaft, both for retaining and recovering the levers, are of the compression type and that the rapier of the second lever is nonmagnetic, but including a permanent magnet so that its behavior is bi-positional, which particularity enables the displacement of the frame on the synchronous shaft in a very simple manner within the stationary half-bar at the desired measure, for adjusting the standard bar. This synchronous shaft has groove therein, at cadence distances, from the locking recesses, so that the grooves serve as references for positioning the frame of the second lever, inserting the magnetic rapier, and once screwed proceeding with the manual break of the surplus synchronous shaft, for then cutting into a generic manner the half-bars and proceeding again to the new assembly.

Moreover, the locking mechanisms in spagnolettes modularly include the same latch of the main bar, as well as the same self-locking system, the same pivoting rod and identical retaining rods. These rods are articulated in a new skid grooved at its base for limiting its movement by a boss integral with the frame and covered with a polyamide guide bushing. This also retains the return spring of the stem attached to the frame through a shaft.

This stem is guided at its end by the crenellation provided in the frame.

Another improvement that involves the invention, lies in the fact that when joining a tandem for physically disabled people, the basic element is to include a shaft that with minimal movement and extensive post-race, allows the release of some “inverted levers”, pushing the corresponding shuttle, and due to the nexus of the spagnolette to the rod tandem, moving with minimum effort this shaft from resting position, a spring being the only element to restore the operating cycle of the bar for physically disabled people.

The selection of materials for the few modular elements, with minimal movements, friction and the implementation with compensating compression springs and the reduction of forces in cascade, result in a minimum of counterforce vector.

The integration of complements for its total or partial electrification, by eliminating complementary elements (air-cups, electric locks), their cost of implementation and aesthetic, results in a high-reliability and durability product, a very low energy assembly and a reduction of noise pollution.

In the mechanisms of horizontal spagnolettes, with regard to the vertical ones the skid is slightly modified, being provided with a double angular embossment and sliding guide on the frame base.

Likewise, to the mechanical (modular) frame some transverse supporting elements are joined, depending on its hand, which have a guiding function so as the angular retainers are aligned with the spagnolette along the guides of the head supporting element on the rod dowels. This alignment is complemented by including into the shank or spagnolette a design guide supporting element contained into three points, pitch diameter of which is slightly greater than that of the shank, this difference in diameters intends to house, during mounting, a bushing that after attaching the guide will be moved from the crenellations being positioned by gravity on the lower stoppers of the shanks, thus eliminating the possible friction that would occur without this accessory between the bar and the spagnolette mechanism.

The same concept applies for the installation of a second bushing, disposable after assembly, on the rod dowel ensuring the adjustment in a simple and unambiguous manner, and the clearance needed for the proper functioning of the spagnolette mechanisms.

Another element that has been object of study is the locks. In both the simple visual inspection is sufficiently explicit. That on the ground is formed by a crenellated supporting element that places an impeller with a protective envelope.

The adjustable side lock is configured by a supporting element that transversally houses a cam-rocker joined to the support element through a shaft mounting a dual-coil return spring. This rod bearing, at its anterior end, a double male-female impeller and the position thereof being regulated, with respect to the plane of incidence on the latch, by a simple screw that acts on the posterior addendum. Once attached and regulated this mechanism is covered and attached with its corresponding envelope.

### BRIEF DESCRIPTION OF THE DRAWINGS

In order to facilitate the understanding of the characteristics of the invention and being an integral part of this specification, the some layout sheets are attached, in the figures of which, with an illustrative and not limitative manner limiting, the following has been represented:

FIG. 1.—It is a partially sectioned elevational view of the envelopes making up the rocking-side hinged/abatable-sliding bar.

FIG. 2.—it is a section of the stationary half-bar.

FIG. 3.—It is a plan view of an integral configuration of the system according to the invention.

FIG. 4.—It is a plan view of the same mechanical configuration of FIG. 3, without the supporting element and the spring of the locking lever.

FIG. 5.—It is a partially sectioned elevational view of the main mechanisms housed in the main head frame.

FIG. 6.—It is an enlarged view of detail A in FIG. 5.

FIG. 7.—It is an enlarged view of detail B in FIG. 5.

FIG. 8.—It is a partial elevational view of the final configuration according to FIG. 3.

FIG. 9.—It is a schematic view of the frame and a complementary lever in its disengagement prior to the movement.

FIG. 10.—It is an elevational view, similar to that of FIG. 9, of the new positioning, locking and breaking of the surplus synchronous shaft.

FIG. 11.—It is an elevational view, similar to that of FIG. 10, by the rear part.

FIG. 12.—It is an elevational view, similar to that of FIG. 11, of the complementary lever frame.

FIG. 13.—It is a side elevational view, in the direction of the arrow C in FIG. 12, showing the mechanism of the magnetic rapier.

FIG. 14.—It is a sectional longitudinal partial elevational view of the frame of the spagnolette mechanism in its resting position.

FIG. 15.—It is a view similar to that of FIG. 14, in the aperture position of the door.

FIG. 16 .—It is a view similar to that of FIG. 15 in the position corresponding to the closure of the door.

FIGS. 17 and 18.—These are sketches corresponding to the positioning of the spagnolette rods of the alternative movements according to a plan view of the conventional mechanism intended to be optimized with the invention.

FIG. 19.—It is a plan view of a configuration that according to the invention joins the main electromechanical bar, in this case, with an auxiliary bar to be actuated by physically disabled people.

FIG. 20.—Shows in two positions a) and b) the section obtained by a cutting plane through the line D in FIG. 19.

FIG. 21.—Shows the spagnolette frame joined, in one of its symmetric configurations, to the side frame.

FIG. 22.—Shows the angular retainer corresponding to the configuration generated in the assembly.

FIG. 23.—Perspective of the guide supporting element for the spagnolette and corresponding bushing for its adjustment.

FIG. 24.—Shows another view of the spagnolette, integrating the support of its return spring.

FIG. 25.—Shows different projections of the skid in the horizontal spagnolettes.

FIG. 26.—Shows the plan and elevational view of the assembly of the vertical spagnolette sub-assembly to the main bar, with the adjustment elements not yet removed.

FIG. 26A.—Shows the perspective of the assembly of the vertical spagnolette sub-assembly to the main bar with the adjustment elements not yet removed, of FIG. 26.

FIG. 27.—Perspective and exploded view of the essential elements making up this ground lock.

FIG. 28.—Perspective and exploded view of the configuration of adjustable side lock.

### DESCRIPTION OF THE PREFERRED EMBODIMENT

Referring to the numbering adopted in the figures, improvements to modular evolutive systems for use in panic bars and similar locks, which are contemplated by the invention, can clearly be seen and preferably in rocking-side hinged/abatable-sliding and doubly rocking latches.

The nomenclature used in the designation of the parts involved in the description is as follows:
1. Stationary half-bar
2. Movable half-bar
3. Head case
4. Rear case
5. Latch
6. Self-locking clutch
7. Self-locking lever
8. Retaining stopper
9. Head supporting element
10. Head frame
11. Bar follower
12. Locking lever
13. AR/RF coil supporting element
14. Transmitting rod
15. Pivoting rod
16. AR coil armor
17. AR coil core
18. Coil reel
19. Washer
20. Abatable-rocking latch shaft
21. Rocking-sliding latch shaft
22. AR core dielectric
23. Main pivoting rod bar locking shaft
24. Self-locking shaft
25. RF retaining guide shaft
26. Operating lever rockers
27. RF spring
28. Fuse
29. Main locking spring
30. Main shutter-unlocking shaft
31. Modular (bar) skid
32. Skid-retaining rod crimping shaft
33. Electromechanical frame
35. Operating second lever frame
35′. DF first lever frame
36. Synchronous shaft guide bushings
37. Synchronous shaft
38. Latch stopper bushings
39. Frame separating shaft
40. Separator-frame shaft bushing
41. Electromechanical shutters
42. Integral configuration shutters
43. DF configuration shutters
44. Dowel, DF configuration shutters
45. Movable armor
46. Inhibiting core
47. Integral spring
48. Electromechanical spring
49. Operating lever spring
50. Permanent magnet
51. DF spagnolette rod-operating bar
52. DF spagnolette rod-main bar
53. DF spagnolette
54. Movable half-bar guiding shaft
55. Operating lever rotation shaft
56. Lower shutter bar lever shaft
57. Rocking guiding shaft
58. Non-magnetic rapier
59. Spagnolette rods
60. Spagnolettes-rods shaft
61. Rod dowel, spagnolette retainer
61′. Disposable bushing for the adjustment between the rod and the spagnolette mechanism
62. Dowel forwarded
63. Rod dowel, in DF configuration
64. DF shaft
65. DF shaft spring
68. Frame, rear case
74. Spagnolette mechanism frame
75. Spagnolette skid
76′. Horizontal Spagnolette skid
77. Stem for positioning spagnolette skid
78. Spagnolette skid spring
79. Stem-skid shaft in spagnolettes
80. Rod skid shaft, in spagnolettes
81. Skid limiting shaft, in spagnolettes
82. Dampening bushing of the limiting shaft
83. Guide supporting element
84. Vertical spagnolettes
84′. Spring supporting element of the horizontal spagnolette
85. Horizontal spagnolette frame
85′. Side frame of the horizontal spagnolette
86. Angular retainer
86′. Limiting dowels for the angular retainer
87. Spagnolette guiding supporting element
87′. Movable bushing for adjusting the spagnolettes
88. Ground lock supporting element
88′. Ground lock impeller
89. Ground lock envelope
90. Adjustable side lock envelope
91. Adjustable side lock supporting element
91′. Guide cylinder for regulating the rod
91″. Rocker shaft guides
92. Rocker rod
92′. Rocker addendum
93. Rocker retaining spring
94. Male impeller
94′. Female impeller
95. Rocker shaft
96. Rod positioning screw
M6. Compensating spring
M7. Compensating spring
M15. Compression spring
M84. Return spring for spagnolettes with horizontal mechanism
T83. Screw

As for the evolutive systems (evolutive envelopes) it can be seen that in the stationary half-bar 1 (FIG. 2) the profile extrusion is due to new functional applications from the known art with respect:

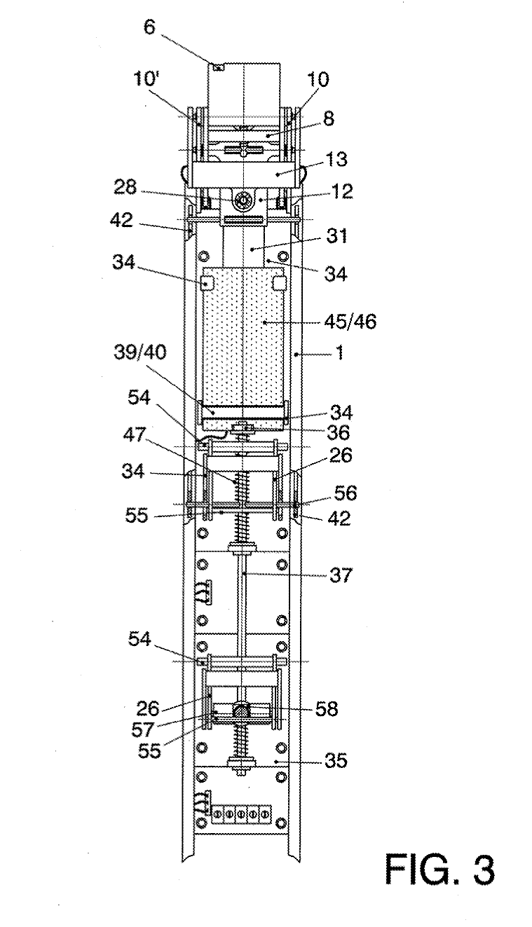

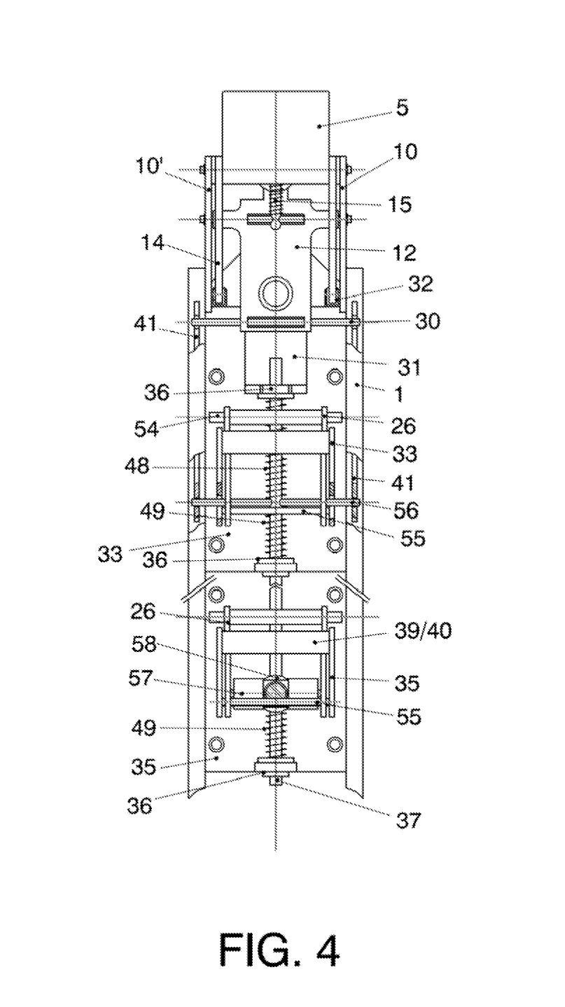

To the proper alignment and movement of “the shutters” (41-42-43) in FIGS. 3 and 4, the latter in bars for physically disabled people, a new element being operated and ultimately responsible for the manual aperture from inside.

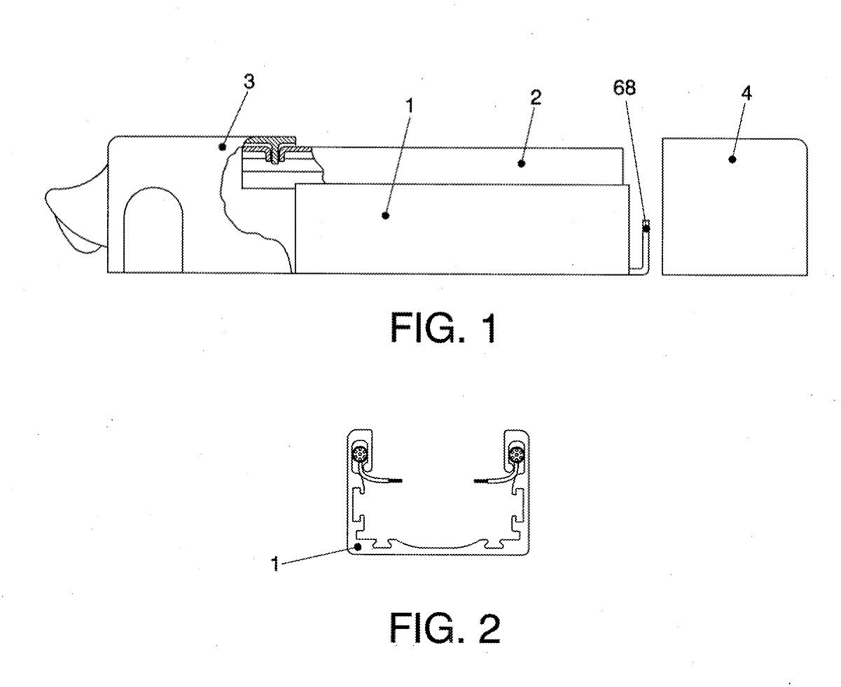

To the prewiring location and the strangulation of this channeling for the correct exit of single-drivers ensuring no collision with the movable half-bar 2 (FIG. 1) or other elements. See one-line exits on the left side of FIG. 3.

To the implementation of reinforced sections for providing the strength required by the pressures from 5000 Nw that necessarily has to be withstood when the system includes the inhibition or electromagnetic retention (45-46) (see FIG. 3).

To the assembly, the movable half-bar 2 (FIG. 1) has a hole in the front for housing and serve as a guide in its short route to a dowel (seen in the section detail of FIG. 1, which incorporates the head case 3. This simple functional solution adjusts the longitudinal movement, with no additional elements. This solution provides rigidity, clean execution and element economy.

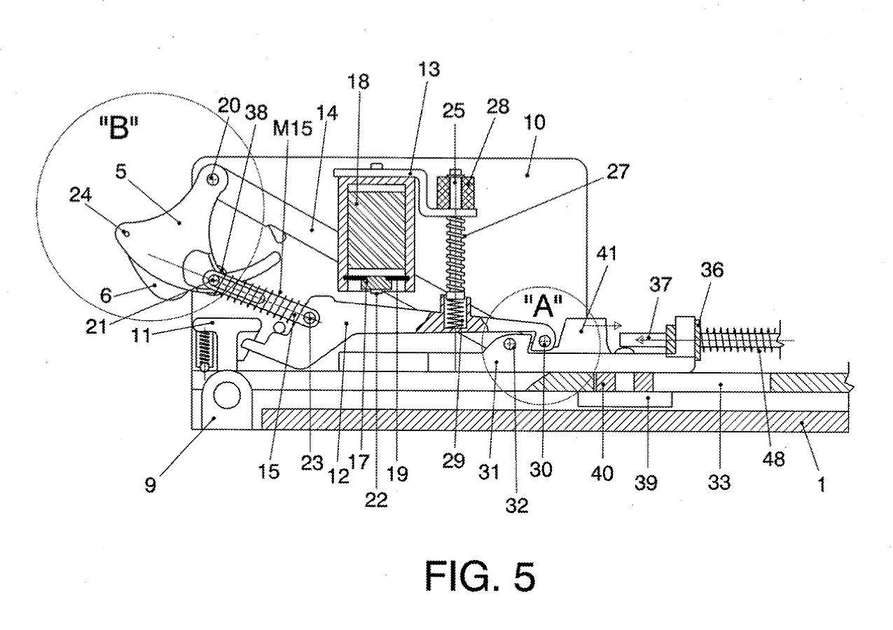

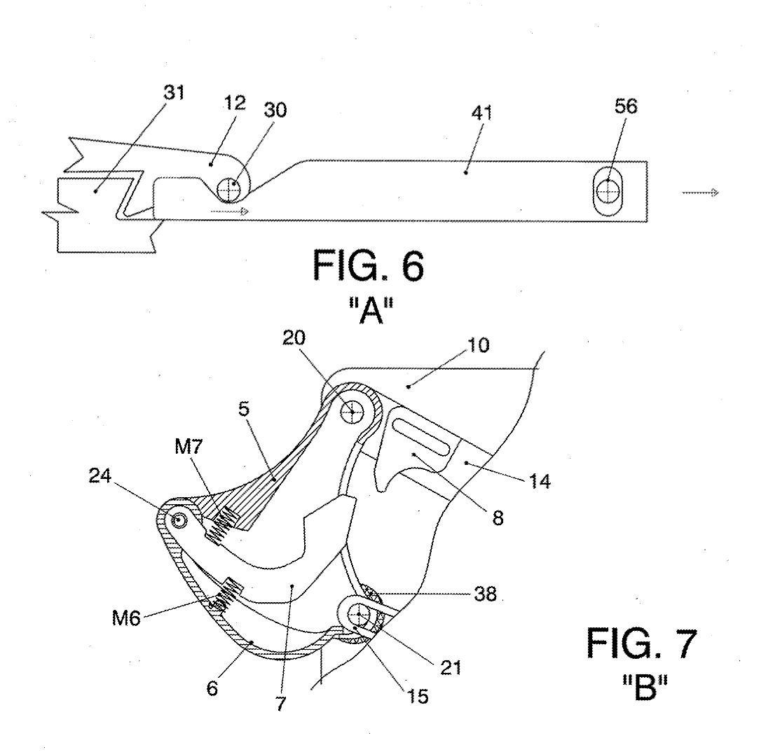

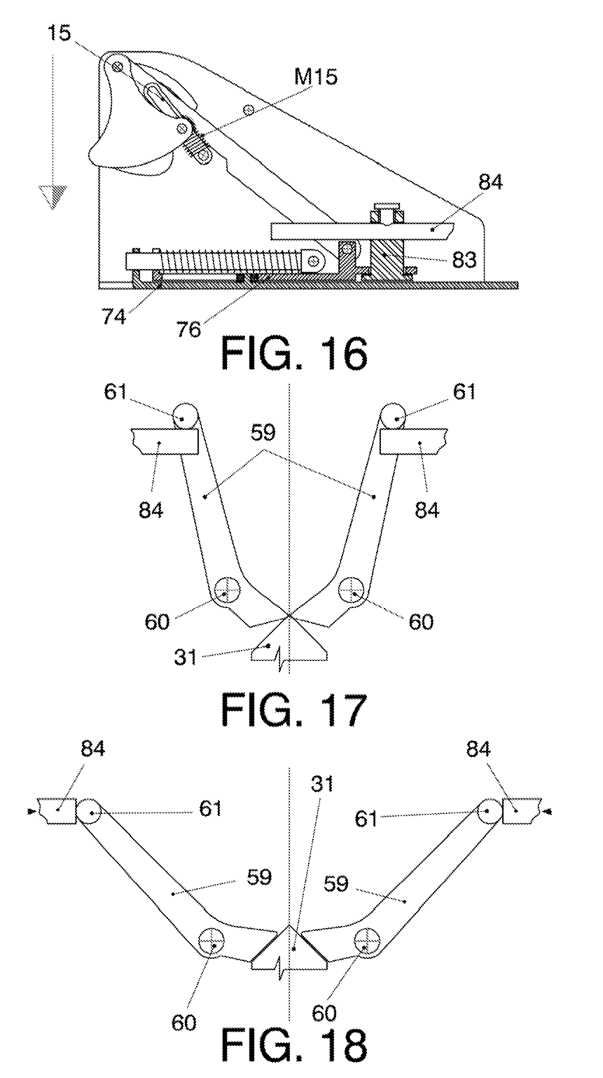

Another improvement of the invention referred to the implementation of compression spring and dynamic compensation in order to optimize the regulation on minimal efforts for the aperture, removing the torsion springs of the known art, these can be seen in FIG. 5 and their enlarged details A and B shown in FIGS. 6 and 7, respectively. The partial hollow of the latch 5 with the lateral movement of the elevated self-locking member (compensating compression springs M6 and M7 scale), enables, during the rocking route on the shaft 21, housing in the latch 5 a rod 15 grooved and pivoting on the shaft 23 of the locking lever 12. Between both shafts compression spring M15 is housed. This alternative provides two advantages: first is to remove the classic torsion spring in latch heads, and the second, arguably more importantly, is to perform its specific function “positioning the latches in their emerging position” and only act (FIGS. 15 and 16) as a recuperating member when the door is closed, both in the spagnolette mechanisms and in the main bar. Instead, “there is no a counterforce for the aperture movement,” both from inside and from outside.

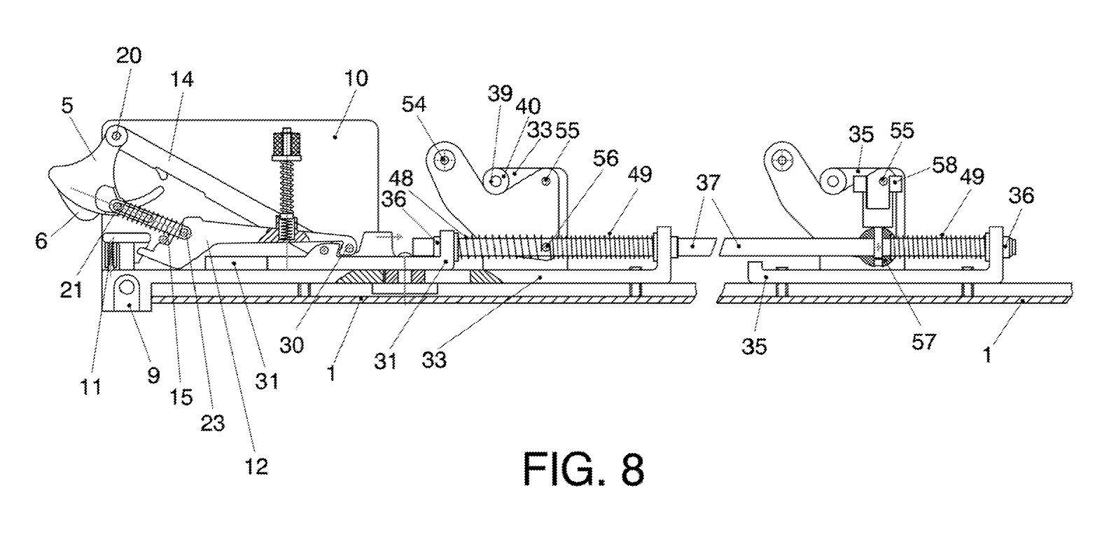

Alternatively, in order to also achieving a small force required for the aperture (according to Standard 4.2.1), such as shown in FIG. 8, there are two levers or rockers 26 rigidly joined by two rapiers 56 and 58 to a bar or synchronous shaft 37 within two U-shaped frames 33 (electromechanical frame) or 34 (integral frame), and movable frame 35, these rockers 26 being articulated at their midpoint 55, such that the upper shaft 54 slightly moves along the rails, which for such purpose maintains the half-bar 2 moving (FIG. 1) or operating.

It is noteworthy that the recuperation springs 47, 48 and 49 (FIGS. 3 and 8) are compressive sliding on the synchronous shaft 37 and are located between the lower shafts of the rockers and the crenellated grooves, with the referred levers or rockers being provided with self-lubricated bearings 36, both in the frames themselves and in the skid 31 with or without electromagnetic armor.

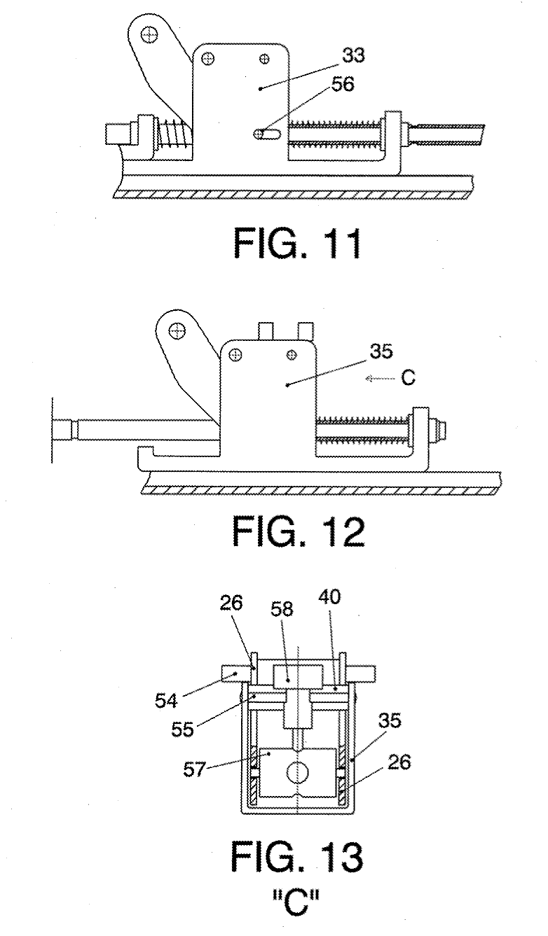

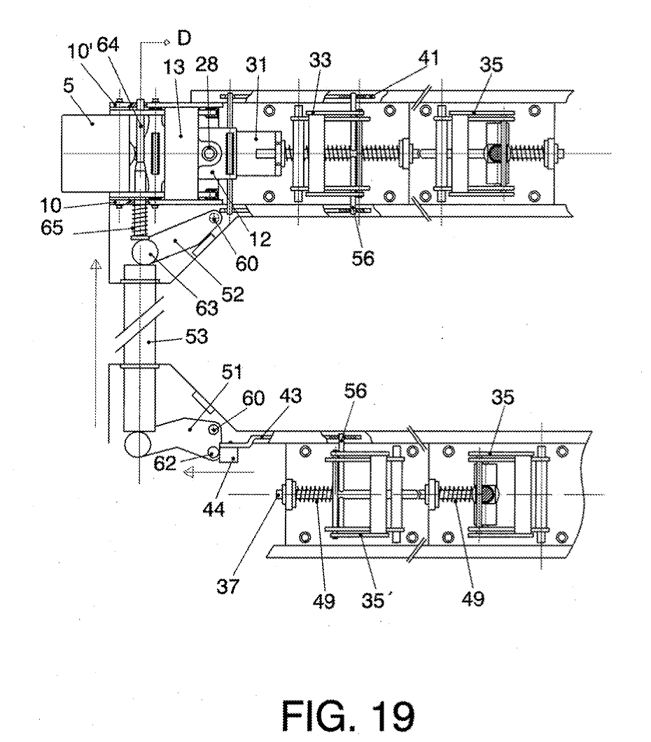

Noting the “U”- shaped frame wherein the first (34 integral, 33 mechanic and 35′ for physically disabled people disabled) lever is housed, there is a longitudinal groove into which the lower shaft 56 of the levers or rockers 26 plays, which is located in the respective frame 33-34 (FIGS. 8 and 11) and frame 35′ (FIG. 19) to the height of the lower rotation shaft 56 of the levers or rockers 26, which groove is intended for enabling, because of its channel, the emergence of said shaft 56 and connecting with the shuttles (41, 42, 43) which in turn have other transverse groove for absorbing said pendulum effect (see detail A in FIG. 6). In this detail is also seen that when actuating on the movable bar with minimal movement, a shrink movement in the favorable sense is generated on the shuttles 41, unlocking the retaining system.

In FIGS. 3 and 4 and FIG. 8 the synchronous shaft 37 is of dynamic compression according to the working sequences thereof:

In a first sequence (static position) the springs 49 housed in the bar or synchronous shaft 37 of the operating levers, is responsible for the recovery of the movable half-bar 2 weight and the small push of the spring (47-48) for positioning the block corresponding to the latch 5, this with no antagonistic spring.

In a second sequence (unlocking) acting on the movable half-bar 2, the shuttles 41, with minimal movement (see FIG. 6) release, by acting on the shaft 30, the retention exerted by the locking lever 12 on the modular (bar) skid 31.

In a third sequence (retraction of the lock), by still acting on the movable half-bar 2, once the lock is released, a post-race is immediately produced, which added to the initial movement decreases the elongation, increasing the effective working length of the springs (47-48) for positioning the lock on its retraction.

In a fourth sequence (restoration), once the door is released from its frame, the vectors generated by the three springs of the synchronous bar are added together, making up the system again.

In the fifth sequence (closing), the elastic spring of the pivoting rod 15 that joins to the latch 5 and the minimum friction generated under its inclined plane are the only forces presented by the bar for its re-hooking.

This arrangement contemplates the basic application of Hooke's Law for producing a balance of forces with very low torque in all sequences. With this working mode, the dynamic compensation synchronous axis is best achieved by compliance with the European Standard EN1125 having as premise a safe and effective evacuation through a door with minimal effort.

As for the versatile retaining system performed by the locking lever 12, given the particularity of the mechanism for releasing, and not for dragging, in the conventional panic bars, having the double rocking latch 5, the most sensitive elements have a different particular design.

FIG. 5 shows that on the locking lever 12, made of a solid of equal resistance and casting alloy, crenellated in its two shafts (23, 30) the following seven functions are carried out:

Through the external operating device, the aperture square bar rotates the follower 11 on the addendum of the locking lever 12. Its rigidity is such that the external device allows unlocking the skid 31 even, after remelting the fuse 28 at high temperature and facilitating the intervention of firefighter.

The shaft 64 for physically disabled people acts on its adjacent addendum, which moves through its spagnolette, the complementary bar for these.

In its rotation shaft, double crenellated, a pivoting rod 15 with its return spring M15 replacing the classic torsion spring, emerging positioning of the latch, is articulated.

On the area closer to the rotation shaft is the remote and side-hinged aperture coil 18. The dual dielectric that has on the one hand the core 17 at its base 22 and the constructive fact that the locking lever 12 as a function of armor, when is attracted by the coil 18, maintains a residual gap, does not allow residual magnetism.

Then the lever 12 shows an embossment into the bottom of which a compression spring 29 limited in its movement along the shaft 25 for the recovery of said lever, is housed. This shaft, slightly doomed in the embossment, has the added function of ensuring (when temperatures are close to the deflection curve of spring 29 by the remelting of the calibrated polymer, thermal fuse 28) the firing of its spring 27 causing the interlock of the locking lever 12. In response to the RF Regulation.

Then the protrusion retaining, under a small negative angle, the skid 31 in locking position (see FIG. 6) is located at the front.

Another improvement of the invention is determined by the flexible system for optimizing Section 4.1.9 of the Standard (as specified in the Background of the Invention paragraph). Levers, on which the movable half-bar 2 acts, must be rigidly joined and at the end points of the bar so as to prevent torsions and consequently the inefficiency of the system.

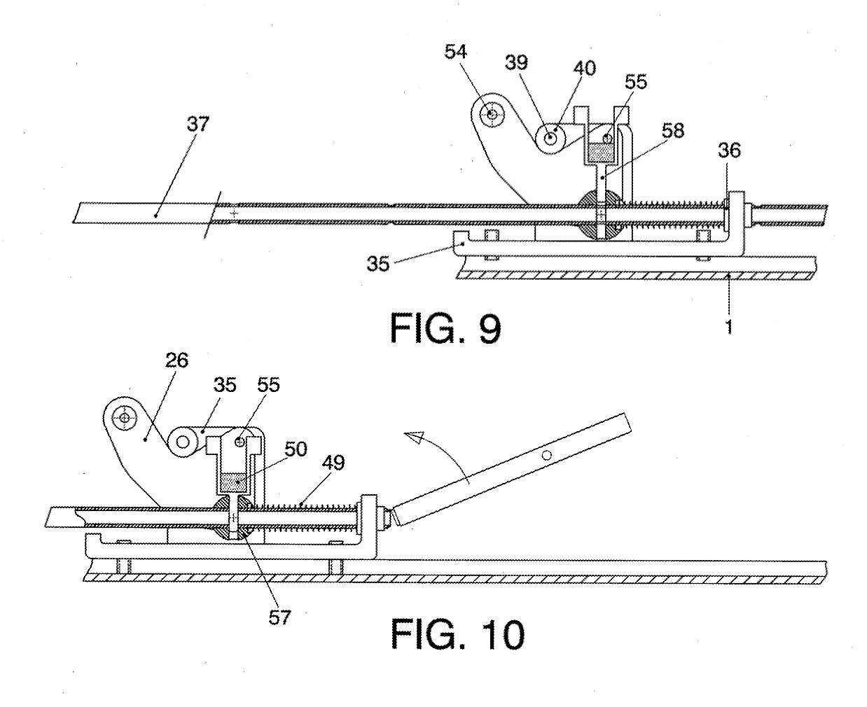

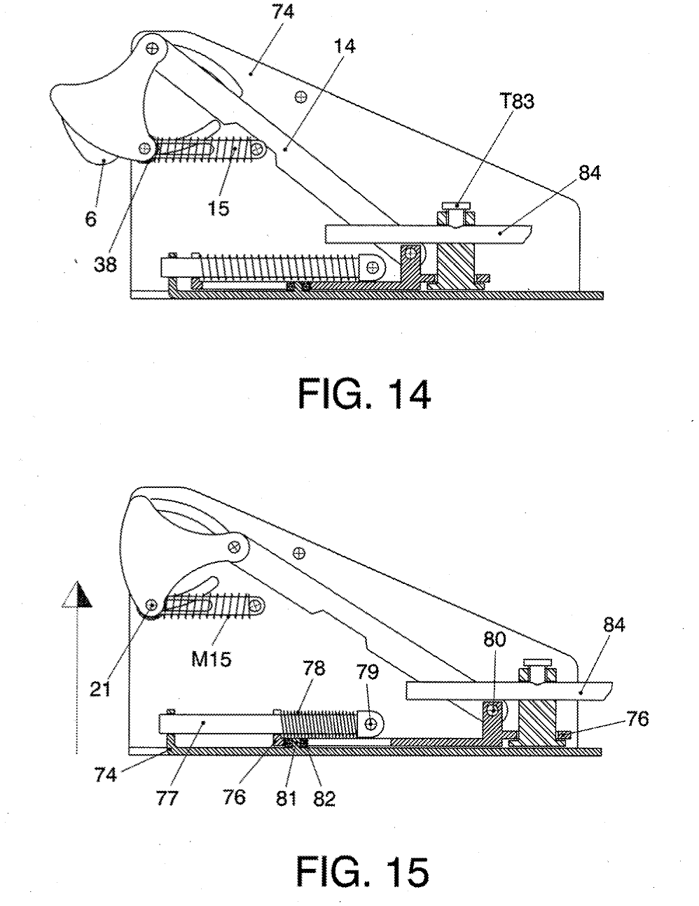

Synchronous shaft 37 (FIG. 8) has tubular configuration and is machined, being provided with a drill-hole in the outer part of the functional head for housing the shaft (rapier) of the levers-shuttles 56 and according to the standard selected, several transverse drill-holes are cadence distanced from the first, with guidelines for these holes, some grooves, which without diminishing the resistance of this synchronous shaft 37 to the traction, do allow its rupture, by manually applying a transverse force (see FIG. 10). This new system is complemented by including within the rockers of the operating lever 26 two new elements: the first, according to a partial section view of A in FIG. 12, corresponding to FIG. 13, is a rocking guide shaft 57 made of steel, double slender, articulating its ends in the lower holes of rockers of the operating lever 26 for housing thereof. This shaft is drilled two diameters and transversely at its geometric center, on the one of larger diameter the synchronous shaft 37 is moved, and on the smaller diameter a nonmagnetic rapier 58 which has the distinction of containing a permanent magnet 50 is housed. This second element, nonmagnetic rapier 58, is manually lifted and remains suspended releasing the synchronous shaft by the container action that creates the field on the rotation shaft of the lever 55, also made of steel. Once the longitudinal rails are unscrewed (see FIG. 9), which for such purpose carry the stationary half-bar 1 (see FIG. 2), “the subassembly is moved to the required position”, such that for interlocking again the new nonmagnetic rapier 58, the groove adjacent to the selected drill-hole serves as reference. The rapier is lowered with minimal pressure (as lifted) being strongly retained in its new housing and feasibility locking the synchronously shaft thanks to higher field generated on the shaft 57. It is fixed through the four screws thereof to the stationary half-bar 1 and then the surplus of the synchronous shaft 37 (see FIG. 10) is “manually, without tools” broken. Finally, as generic, the half-bars 1 and 2 are cut and the new assembly is performed. With regard to the new system of latches in spagnolettes, unlike conventional construction of the spagnolette self-locking latch that is optimized, according to FIGS. 14, 15 and 16, and following the same philosophy as the bar, the spagnolette latches maintain the same elevated self-locking clutch member 6 without antagonistic resultant vector, and the replacement of the classic torsion spring of the upper shaft of the latch by a pivoting rod 15 with its compression spring M15. The transmitting rods 14 act joined to a new skid 76 hooked through the shaft 80. This skid 76 has a groove at its base and its route is limited by a shaft 81 jointly connected to the frame 74, this shaft being as all shafts of the bar frames, surrounded by a bushing 82 dampening the collision of the position corresponding to FIG. 15 for passing to that shown in FIG. 14. Other bushings made of polyamide 38 are on the shaft 21 for dampening the collision of the position of FIG. 16 to that shown in 14, the same way as in the main bar.

A stem 77 is retained by the shaft 79 jointly connected to the frame 74, and includes a return spring 78. This stem is perfectly positioned between the inverted crenellations of the frame 74 and those of the skid 76, the skid bearing a housing on the back for containing the attaching guide supporting element 83 of the spagnolettes 84, held by the dowels 61 which include the spagnolette rods 59 and, which are released with minimal effort, when the skid is moved from the bar 31, as shown in the positional diagram of FIGS. 17 and 18, respectively corresponding to the positions of FIG. 15 and those of FIGS. 14 and 16.

It is noteworthy that this spagnolette system proposed by the invention, by being for releasing and not dragging, in case of an incorrect attachment of screw T83 retaining the spagnolette 84 in the guide supporting element 83, “it does never lock the emergency exit”.

Regarding the operating system for use in emergency exits for physically disabled people, as mentioned above, the locking lever 12 had an embossment that could act on the shaft 64 for physically handicapped people, releasing the lock.

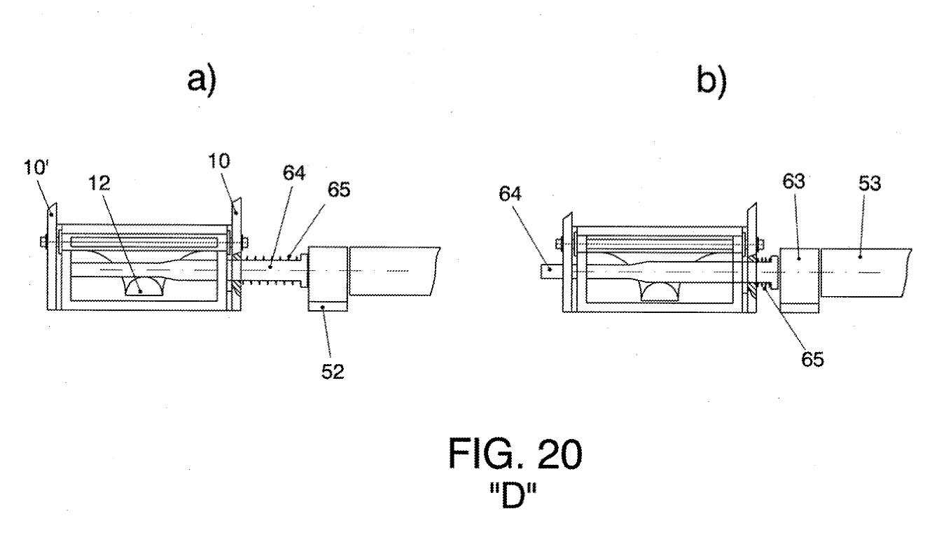

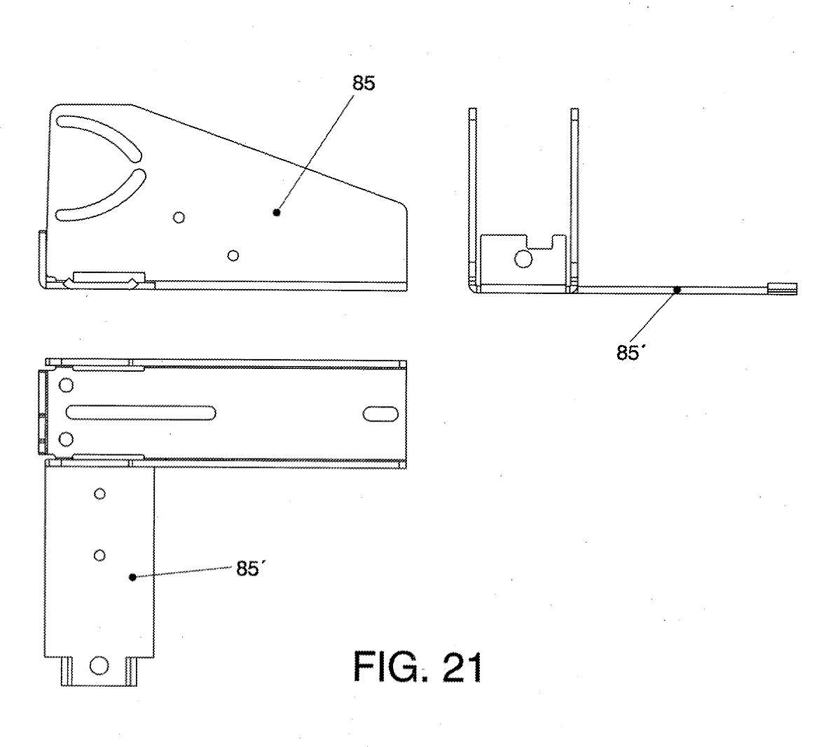

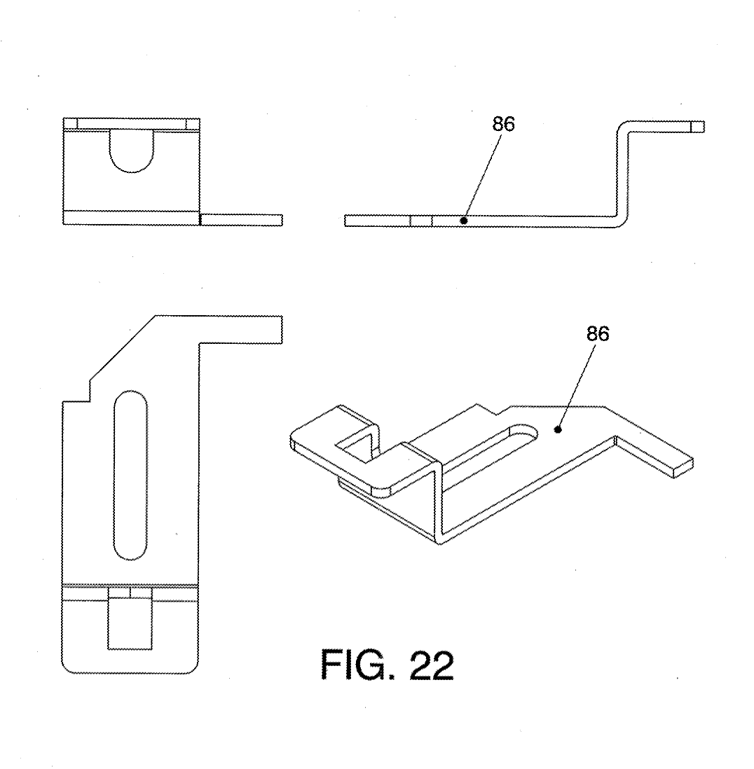

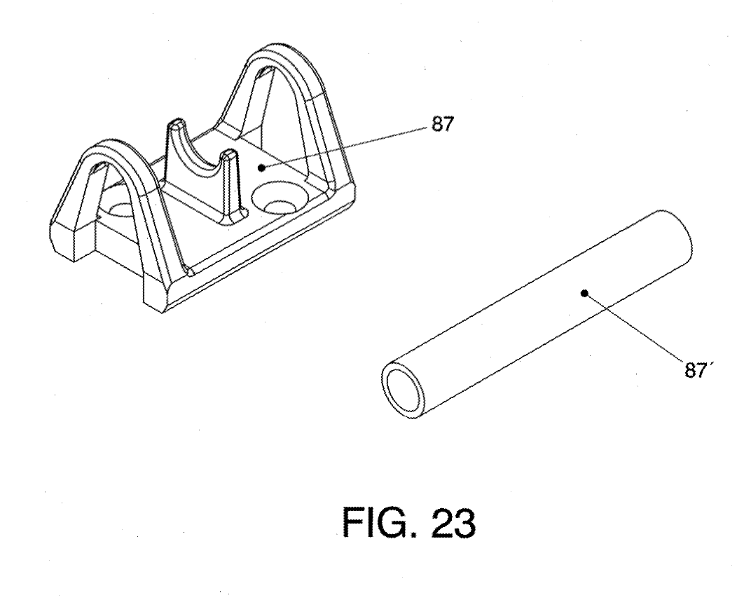

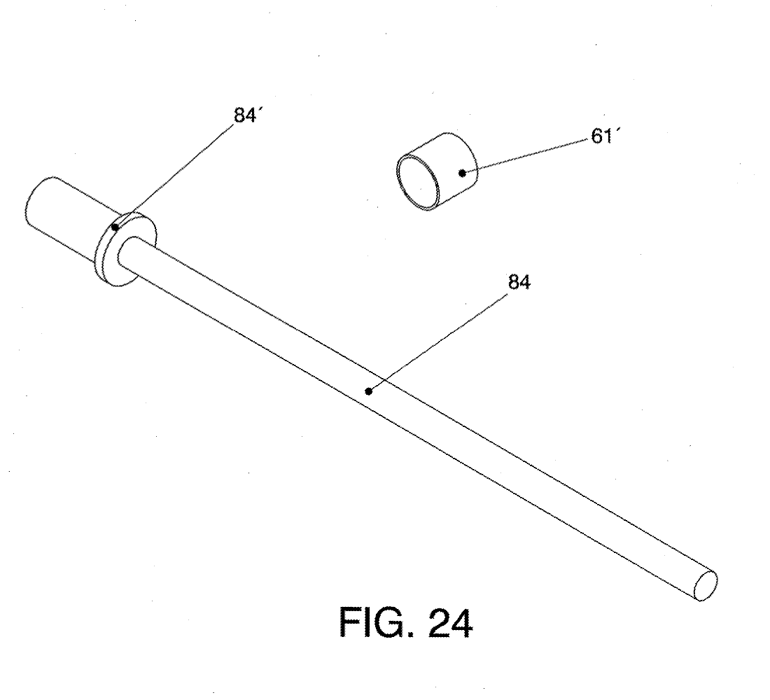

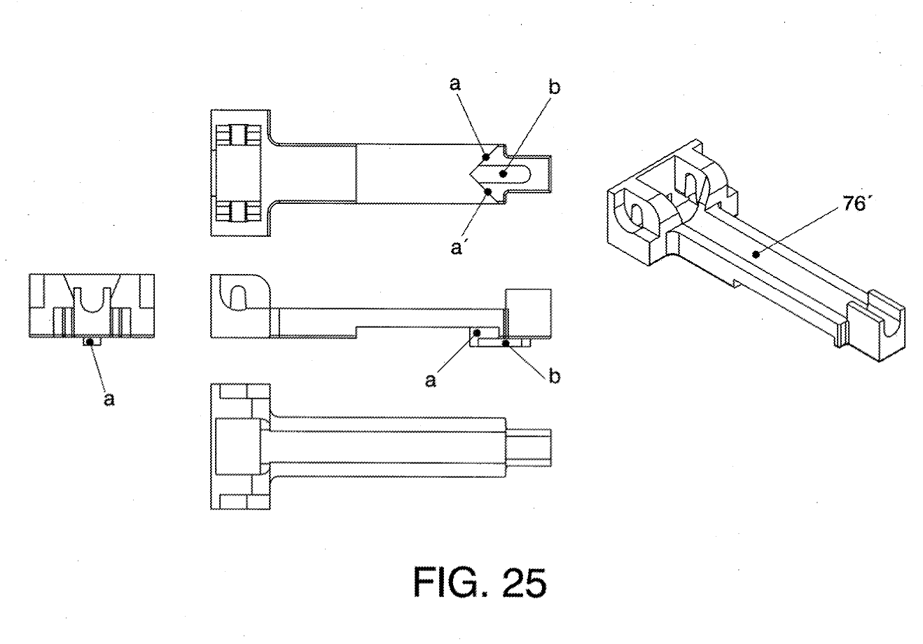

In FIG. 20, corresponding to a section along the cutting line D in FIG. 19 is shown in two positions a) and b) the schematic form of this application for physically disabled people. It is a simple combination consisting of a mechanical locking bar, in this case electromechanical, wherein the shaft 64 is housed, revolution cylinder to three diameters, the largest serves for supporting the spring 65, the second diameter serves as guide between the first wall of frame 10 which retains that compression spring 65 already within the frame, and after the cone-shaped machining, its third diameter is perfectly guided in the second wall of frame 10′, this mechanism being retained by the positioning of the dowel 63 integral with the rod 52.

The second component of the referred combination is determined by the auxiliary bar for physically disabled people, it is “rigorous” with four operational components: two “inverted” levers joined through the synchronous shaft 37 with respective return springs 49 even more flexible than the configuration of the upper bar, because its function is simply to recovery the weight of its movable half-bar 2.

A single shuttle 43 (right or left) according to the rotation of the door to which it is intended, that at the front incorporates a pusher dowel 44 and rod 51 for shutting of spagnolette 53, practically symmetrical to the rod 52.

The spagnolette 53 which moves between the guides of the supporting elements of both bars performs the connection and the operational function of this application.

In this tandem a main electromechanical bar is applied in order to optimize the exit, since by physically actuating on the bar for physically disabled people, the rod 52 acts on a switch for enabling a timed electric aperture, which function requires no permanent pressure actuation on the movable half-bar 2, just exerting a first impulse.

With that tandem and from the electrical signal described, of the main bar and in a deficiency manner, another signal can be sent for the door motorization and automatic aperture.

In all configurations for physically disabled people, the pressures that have to be exerted are practically only to overcome the hydraulic spring included in the door for positioning thereof.

This family of modular bars with small linear movements and flexible compression springs, commits, by sacrificing the pure competitiveness, to the reliability of its components seeking solutions in alloyed foundries specific for the involved elements with greater responsibility, generating solids of equal resistance.

The cascade tension reduction design, the implementation of the compensating compression spring and advantage levers for being actuated, result in a vector of minimal effort, and consequently in those electrical, in a low-energy consumption. The power supply needed for its control, with inhibition, does not exceed 3.5 W. In the case of power failure “under remote aperture”, with or without inhibition, the electrical panic bars instantaneously behave as RF mechanical bars.”

All guides of: frames, rocking shafts of the latch, lever stoppers and the movement of the synchronous shaft, are covered with polyamides suitable for collision and dimensional stability. This implementation provides minimum friction coefficients, greater reliability and significantly reduction of the noise pollution.

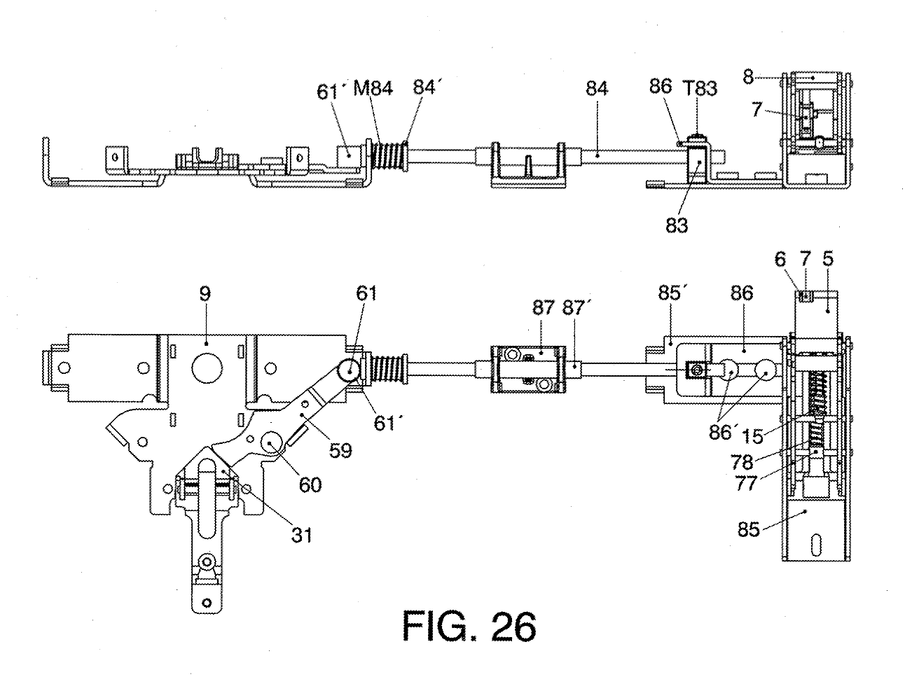

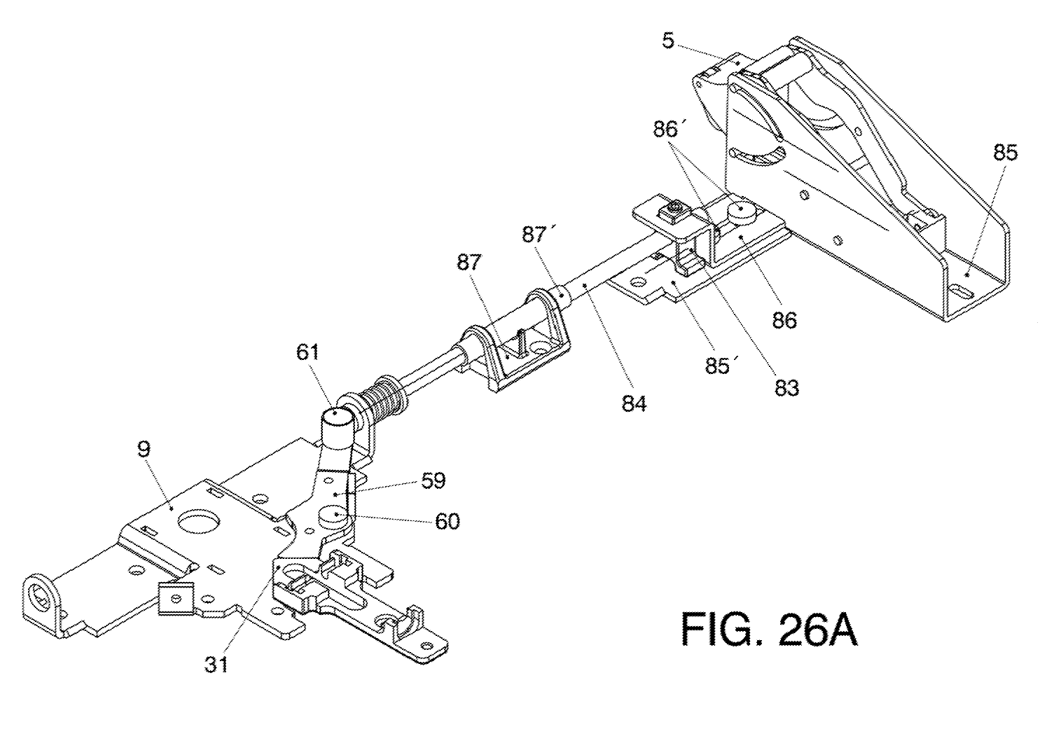

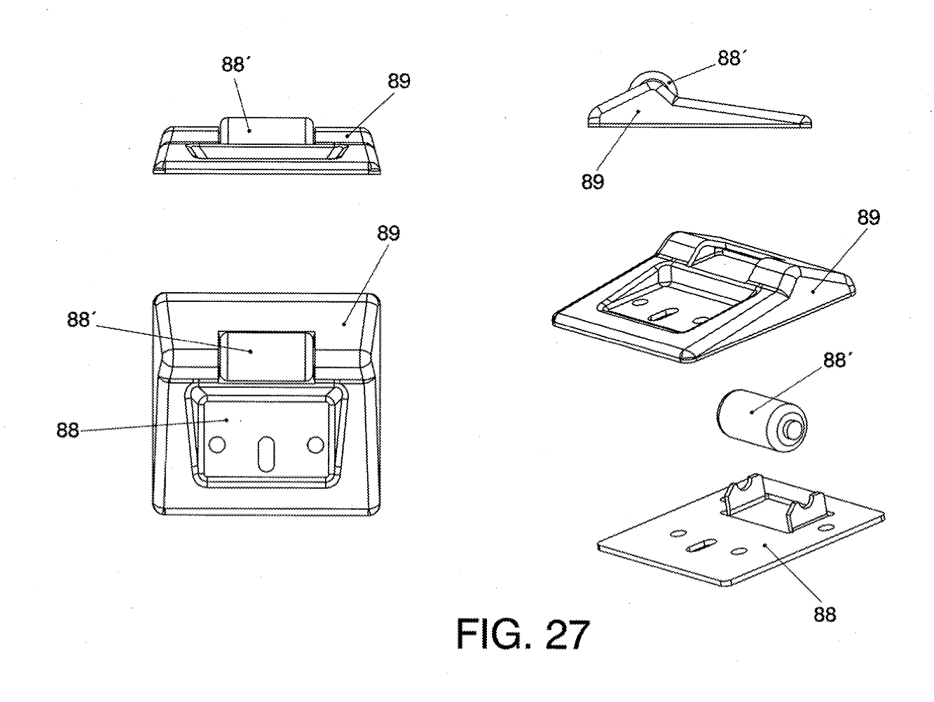

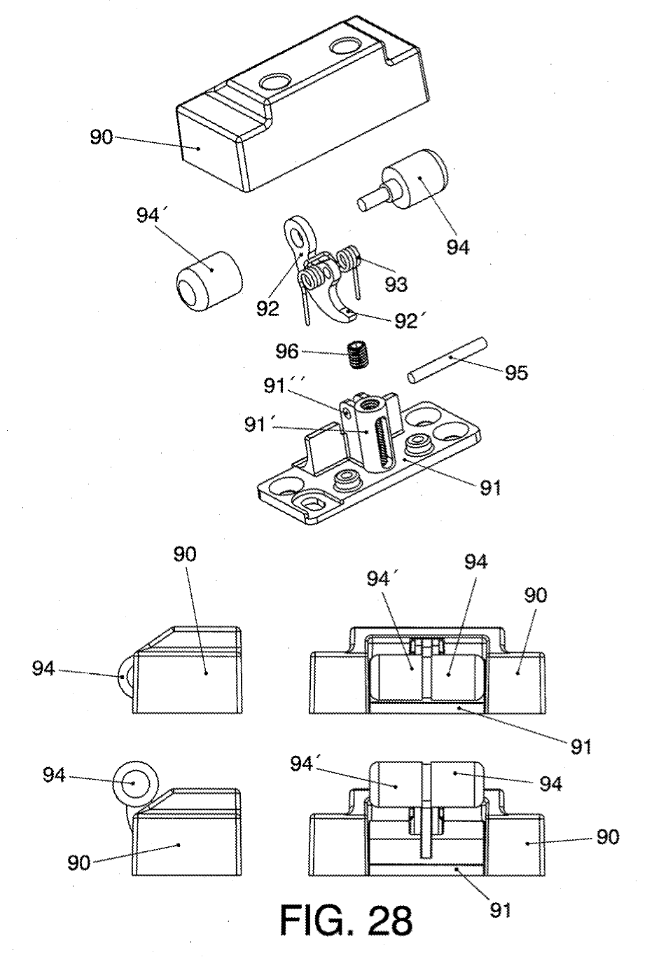

Locking mechanisms in horizontal spagnolettes (FIG. 26) includes, in a modular way, the same elements of the main bar and vertical spagnolettes; the latch 5, the same self-locking system 6, 7 and 8, the same pivoting rod 15, retaining rods 14, the same guide supporting element 83 and the same stem 77 for positioning the skid of spagnolettes . This stem 77 and the rods being articulated on a symmetric skid 76′ including an angular prism(a, a′) and a guide (b) sliding on a groove that has frame of the mechanism for such purpose, which prevents the axial movement of this skid 76′ by being locked by the angular and bent retainer 86, this retainer 86 is moved by the supporting element or transverse frame 85′ in a route limited by the pins 86′ in the sliding guide existing in the angular retainer 86 and houses, with some clearance, in the angled crenellation the common guide supporting element 83 provided with a screw T83 for the straight movement through the spagnolette 84 with the main bar. Thus the variety of bar articulations is complemented with vertical, horizontal or mixed spagnolettes.

This spagnolette 84 is topped with a cap 84′ which aims to adjust the different diameters of the spagnolette shank and guide tabs of the head supporting element, while serving as housing for a compression spring M84 function of which is to recover retainer element 86, after the unlock cycle.

Also, according to the spirit of the title, a guide supporting element 87 is generated, which is common for vertical and horizontal mechanisms, with crenellated design determining a three-point plane for adjusting to the spagnolette 84 with a diameter slightly greater than said shank that enables inserting a bushing 87′ for stiffening the guide supporting element 87, allowing no deviation at the time of attaching the supporting element 87 to the frame, then moving this bushing 87′ from the crenellations being positioned by gravity without interferences on the lower supporting elements of the spagnolettes. With this simple operation the alignment is established without producing any friction during the normal movement of the spagnolette.

The same philosophy allows a precise adjustment when attaching the spagnolettes 84 in their guide supporting element 83 through the screw, and pressing thereof on the second bushing 61′ located on the rod pin retaining the spagnolettes 61, once locked the spagnolette shank 84 this adjustment bushing 61′ is removed and discarded, being the combination well regulated.

Finally and in order to optimize the Standard EN1125, object of the present invention, a redesign on conventional locks has been made, including, for minimizing the friction on the latches, rolling planes.

The actuation on the “ground lock” is very graphic. It starts with a supporting element 88 with two crenellated embossments used as a “bed” for a solid impeller 88′ and in the enveloping 89 making up the sub-assembly, respecting the angles of incidence contemplated by the standard, a window is opened for the correct assembly of these three elements.

In the side lock, its increased complexity is due to the needed correction having thereof, according to the profiles wherein the different heights showed by the door implementing plans with respect to the frames, are installed.

In this adjustable side lock except for the enveloping adjustable side lock 90 the rest of the elements are made in the Standard EN1125.

It begins from a supporting element 91 jointly connected with a threaded and milling guide bushing 91′, this supporting element 91 crenellated in cross-section houses a rocker 92 bearing a double coil spring 93 and inserts into the crenellation of the supporting element 91 and retained by the rocker shaft 95, being attached through drill-holes 91″. This rocker 95 joins with sliding adjustment two male-female impellers 94, 94′ rigidly assembled. The position of the impellers 94-94′ with respect to the plane of incidence of the latch is controlled by a single screw 96 which acts on the radial addendum 92′ of the rocker, the pressure generated by the return spring 93 itself being sufficient for stabilizing the attachment of the screw 96 in the desired position. Once installed the frame supporting element 91 in the right place, the enveloping adjustable side lock 90 is attached to supporting element 91. This mechanism allows the adjustment and readjustment, in case of expanding the parameters implanted, without using the classic supplements of conventional locks.

1. Sliding and modular panic bar with minimum movements, provided with a head case (3) bearing a boss, on which a half-bar (2) slides, through a guide made therein, characterized in that it includes:
a stationary half-bar (1) including a configuration enabling electrical installation with different recesses for prewiring and other connections,
rails for the modular attachment of supporting elements and frames,
crenellations for a correct alignment and movement of shuttles (41, 42, 43),
and in that in the stationary half-bar (1) a modular synchronous shaft (37) is located, being rigidly and cadential attached to rockers of the operating lever (26) through a lower shaft (56) and a nonmagnetic rapier (58); the rockers (26) are in “U”-shaped framed (33 or 34 and 35) and are hinged at their midpoint or rotation shaft (55); the lower shaft (56) connects at its ends with the shutters (41) so that when lifted, under inclined planes and minimum movements, a main unlocking shaft (30) embedded in a locking lever (12) for releasing a modular and sliding skid (31) maintaining, through a electromechanical spring (48) bearing the modular synchronous axis (37), both the positioning of the rods (59) retaining vertical spagnolettes (84) and the positioning of a rocking-side hinged latch (5) through its positioning shafts (20 and 21) by connecting a transmitting rod (14) that articulates said modular skid (31) by a crimp shaft (32) and the latch (5) through its shaft (20);
the rocking-side hinged latch (5) is maintained to the emergence by the pressure of a compression spring (M15) arranged in a recuperating rod (15), pivoting and grooved, between one of the positioning shafts (21) of the latch (5) and a shaft (23) of the locking lever (12), the rocking-side hinged latch (5) comprises an elevated self-locking member (6, 7, 8), forming a compensating spring balance (M6, M7), and
the rocking-side hinged latch (5) has a locking mechanism in spagnolettes and is maintained self-locked when positioned on a impeller (94/94′) hooked on rod-rocker (92) and positioned on its shaft (95) within an adjustable side lock supporting element (91), and remains unoperated in the remaining rocking-side hinged sequences wherein the latch (5) is not positioned on the impeller (94/94′) located within adjustable side lock supporting element (91).

2. Sliding and modular panic bar with minimum movements, according to claim I, characterized in that inside the rails a first supporting element (9) is housed, which joins together the head frames (10, 10′) having a double circular sector for achieving the double depression of the latch (5) on the positioning shafts (20, 21) thereof, the elevated self-locking member (6, 7, 8) of the latch (5) being displaced from its geometric center for receiving the recuperating rod (15) which, by means of the groove therein, moves along the shaft (21) of the latch (5) together with its compression spring (M15), the locking lever (12) having the function of serving as unlocking element, when a follower (11) is actuated on its external and adjacent addendum, sometimes, on a shaft (64) for use in the exit of physically disabled people, also having the function of armor in electrical configurations, housing its return spring and ensuring in its embossment, in case of fire when a fuse (28) is melted, the locking lever (12) is retained by a RF spring (27) maintaining the locking, the head frames (10, 10′) being assembled, at the top, with a supporting element of coil (18) making up the head block stiffness.

3. Sliding and modular panic bar with minimum movements, according to the preceding claims, characterized in that the modular skid (31) is crimped to an electromagnetic armor (45) made of different alloys, same as its core (46) in inhibition applications, being a solid of equal resistance and having at its anterior part a triangular-prism configuration, maintaining in the middle part thereof the parallelism by the situation of some its transmitting rod (14), being a bushed separator with suitable polyamide (39, 40) limiting the movement thereof in the groove of the sliding skid, preventing the metal collision of the latch shaft on the frames (10, 10′), forming on the back an open crenellation wherein a bushing (36) for moving a synchronous shaft (37) is housed.

4. Sliding and modular panic bar with minimum movements, according to claim 3, characterized in that the synchronous shaft (37) is rigidly associated to the operating levers (26), in addition to their lower shafts (56) in the first in a shaft (57) in the second, independently moving not associated to the dragging of the element emerging between the frames of the levers, which just like the sliding skid (31) house in their crenellations, closed at the top and open at the bottom, two separate polyamide bushings (36) loosely in the vertical shaft for absorbing the pendulum effect created by the articulation, when the movable half-bar (2) acts on an operating shaft (54) with a bearing (55), on a lower shaft (56, 57) of the operating levers, the lower shaft (56) or rapier is assembled with shuttles (41, 42, 43) housed in the crenellations existing in the stationary half-bar (1) for such purpose, having envisaged that the springs included in the synchronous shaft (37) both for retaining (47, 48) and recuperating (49) the levers are of compression, the rapier (58) of the second lever is non-magnetic, but when a permanent magnet (50) is included its behavior is biposicional, feature that enables the movement of a frame (35, 35′) on the synchronous shaft (37) in a very simple manner within the stationary half-bar (1) to the extent desired, for adjusting the standard bar, with the synchronous shaft (37) being grooved at cadence distances from the interlocking housings for allowing the manual rupture of the surplus part thereof.

5. Sliding and modular panic bar with minimum movements, according to the preceding claims, characterized in that the locking mechanisms in spagnolette modularly include the same latch (5) of the main bar, the same self-locking system (6, 7, 8), the same pivoting rod (15) and identical retaining rods (14), these rods being articulated in a skid (76) grooved at its base for limiting its movement by a boss (81) integral with the frame (74) and covered with a polyamide guide bushing (2), and which at its front retains a return spring (78) of a stem (77) attached to the frame (74) by a shaft (79), this stem being guided in its extreme by the crenellation included by the frame (74); the skid housing a guide support element (83), function of which is to retain a corresponding shank or spagnolette (84) by attaching a screw (T83).

6. Sliding and modular panic bar with minimum movements, according to the preceding claims, characterized in that when a bar tandem is joined for physically handicapped people, the sliding panic bar further comprises a shaft (64) which with a minimum movement and extensive post-race, enables the unlocking by acting on the complementary bar of some “inverted levers”, frame (35, 35′), pushing the shuttle (43) and because of the nexus of a spagnolette (53) to the rod tandem (51, 52), moving with minimum effort the shaft (64) from resting position, a spring (65) being the only element to restore the operating cycle of the rod or shaft (64).

7. Sliding and modular panic bar with minimum movements, according to claim 5, characterized in that locking mechanisms in horizontal spagnolettes modularly includes the same elements of the main bar and vertical spagnolettes; the latch 5, the same self-locking system 6, 7 and 8, the same pivoting rod 15, the retaining rods 14, the same guide supporting element 83 and the same stem 77 for positioning the skid of spagnolettes, this stem 77 and rods 77 being articulated on a symmetric skid 76′ including an angular prism (a, a′) and a guide (b) sliding over a groove existing in the frame of the mechanism for such purpose, which prevents the axial movement of this skid 76′ by being locked by the angular and bent retainer 86, this retainer 86 is moved by a supporting element or transverse frame 85′ in a route limited by pins 86′ in the sliding guide existing in the angular retainer 86 and loosely houses in the angled crenellation the common guide supporting element 83 provided with the screw T83 for the straight movement through the spagnolette 84 with the main bar, all of this with the aim of complementing the variety of bar articulations is complemented with vertical, horizontal or mixed spagnolettes, furthermore the spagnolette 84 is topped with a cap 84′ which aims to adjust the different diameters of the spagnolette shank and guide tabs of the head supporting element, while serving as housing for a compression spring M84 function of which is to recover retainer element 86, after the unlock cycle.

8. Sliding and modular panic bar with minimum movements according to the preceding claims, characterized in that a guide supporting element 87 is generated, which is common for vertical and horizontal mechanisms, with crenellated design determining a three-point plane for adjusting to the spagnolette 84 with a diameter slightly greater than said spagnolette that enables inserting a bushing 87′ for stiffening the guide supporting element 87, allowing no deviation at the time of attaching the supporting element 87 to the frame, then moving this bushing 87′ from the crenellations being, positioned by gravity without interferences on the lower supporting elements of the spagnolettes, such that the alignment is established with this simple operation without producing any friction during the normal movement of the spagnolette 84, furthermore a precise adjustment is achieved when attaching the spagnolettes 84 in their guide supporting element 83 through the screw, and pressing thereof on the second bushing 61′ located on the rod pin retaining the spagnolettes 61, once locked the spagnolette shank 84 this adjustment bushing 61′ is removed and discarded, being the combination well regulated.

9. Sliding and modular panic bar with minimum movements, according to the preceding claims, characterized in that these include, for minimizing the friction on the latches and rolling planes, a supporting element 88 with two crenellated embossments serving as “bed” for a solid impeller 88′ an in an envelope 89 making up the supporting element-impeller 88-88′ sub-assembly, also a window is opened for the correct assembly of these three elements; except for the envelope 90, the rest of the elements are made of steels;
it also starts from a supporting element 91 jointly connected with a threaded and milling guide bushing 91′, this supporting element 91 crenellated in cross-section houses a rocker 92 bearing a double coil spring 93 and inserts into the crenellation of the supporting element 91 and retained by the rocker shaft 95, being attached through drill-holes 91″, this rocker 95 joins with sliding adjustment two male-female impellers 94, 94′ rigidly assembled, the position of the impellers 94-94′ with respect to the plane of incidence of the latch is controlled by a single screw 96 which acts on the radial addendum 92′ of the rocker, the pressure generated by the return spring 93 itself being sufficient for stabilizing the attachment of the screw 96 in the desired position;
once installed the frame supporting element 91 in the right place, the envelope 90 is attached to supporting element 91, this resulting configuration allows the adjustment and readjustment, in case of expanding the parameters implanted, without using the classic supplements of conventional locks.
